(19) United States
(12) Patent Application Publication
(10) Pub. No.: US 2005/0140675 A1
(43) Pub. Date: Jun. 30, 2005

(54) Method and system to generate an image for monitoring user interaction with a computer

(76) Inventors: Eric N. Billingsley, Campbell, CA (US); Colin E. Matthias, Shrewsbury, MA (US); Lindsey M. Perullo, Revere, MA (US); Steven L. Posnack, Mastic Beach, NY (US)

Correspondence Address: SCHWEGMAN, LUNDBERG, WOESSNER & KLUTH, P.A.;EBAY, P.O. BOX 2938, MINNEAPOLIS, MN, 55402-0938, US

(21) Appl. No.: 10/863,609

(22) Filed: Jun. 7, 2004

Related U.S. Application Data
(63) Continuation of application No. 10/636,085, filed on Aug. 6, 2003, now abandoned.

(51) Int. Cl. G06T 11/20

(52) U.S. Cl. 345/440

(57) ABSTRACT

A method of, and system for, generating an image for use in monitoring interaction between a user and a computer is provided. The method includes generating random reference data wherein the reference data comprises a plurality of characters and randomly selecting a font from one of a plurality of fonts. Each font may comprise a plurality of font images and a font image may be retrieved for each character of the reference data. Thereafter the retrieved font images may be combined. In one embodiment, each font image includes a font background and a user identifiable character defined by removal of the font background so as to define the user identifiable character. In addition or instead, each font image may include a font background including a plurality of font patterns, and a user identifiable character defined by a concentration of the patterns so as to define the user identifiable character.

### RELATED APPLICATIONS

This application is a continuation of U.S. application Ser. No. 10/636,085 filed Aug. 6, 2003.

### FIELD OF THE INVENTION

The invention relates to monitoring user interaction with a computer. In particular, the invention relates to method and system to generate an image for monitoring user interaction with a computer.

### BACKGROUND OF THE INVENTION

A problem that often arises in an Internet environment is that of unauthorized or improper access to web sites by robots, commonly referred to as “bots”. Bots are programs that are run on computers that automatically access a web site without the need for human or user interaction. Although some bots may access a web site for proper purposes, e.g., search engine spiders that are authorized to scrape information from web pages, other bots perform improper functions. For example, certain bots access web sites and register multiple fictitious users for improper purposes, access web site to mine confidential user information, guess user passwords, list items without authorization on sale or auction web sites, and so on. It will be appreciated that, due to the high processing power of computers running bots, a large number of unauthorized accesses may take place in an extremely short period of time. However, although unauthorized access by a user or human may still occur, it is a substantially slower process.

In order to avoid access by bots, web sites may present an image to a user wherein the user is required to identify characters (e.g., numerals) in the image. The user is then requested to enter the characters manually and a comparison is then performed to check if the manually entered characters match those provided in the image presented to the user (e.g., the number provided in the image matches the number entered by the user). It will be appreciated that the image presented to the user should be arranged in such a fashion so as to inhibit recognition thereof by a bot.

### SUMMARY OF THE INVENTION

A method of, and system for, generating an image for use in monitoring interaction between a user and a computer is provided. The method includes generating random reference data wherein the reference data comprises a plurality of characters and randomly selecting a font from one of a plurality of fonts. Each font may comprise a plurality of font images and a font image may be retrieved for each character of the reference data. Thereafter the retrieved font images may be combined. In one embodiment, each font image includes a font background and a user identifiable character defined by removal of the font background so as to define the user identifiable character. In another embodiment, each font image may include a font background including a plurality of font patterns, and a user identifiable character defined by a concentration of the patterns so as to define the user identifiable character.

Other features of the present invention will be apparent from the accompanying drawings and from the detailed description, which follows.

### BRIEF DESCRIPTION OF THE DRAWINGS

The present invention is illustrated by way of example, and not limitation, in the figures of the accompanying drawings, in which like references indicate similar features.

In the drawings,

FIG. 1 shows a schematic block diagram of an exemplary system, in accordance with one aspect of the invention, for monitoring interaction between a user and a computer;

FIG. 2 shows a schematic flow diagram of an exemplary method, in accordance with another aspect of the invention, of generating reference data including a random reference string;

FIG. 3 shows a schematic flow diagram of an exemplary method, also in accordance with an aspect of the invention, of generating an image, readable by the user, including the random reference string;

FIG. 4 shows a more detailed schematic flow diagram of the method of FIG. 3 showing inclusion of the random reference string in the image;

FIG. 5 shows a schematic flow diagram of an exemplary method, also in accordance with an aspect of the invention, of monitoring user interaction with the computer;

FIG. 6 shows a schematic representation of an exemplary user interface presented to the user on the computer;

FIG. 7 shows an exemplary user interface for a visually impaired user;

FIG. 8 shows an exemplary table for monitoring repetitive use of a token;

FIG. 9 shows a schematic flow diagram of a method, in accordance with the invention, to generate an image for use in monitoring user interaction with a computer;

FIG. 10 shows a schematic flow diagram of a further method, in accordance with the invention, to generate an image for use in monitoring user interaction with a computer;

FIG. 11 shows a schematic flow diagram of a yet further method, in accordance with the invention, to generate an image for use in monitoring user interaction with a computer;

FIG. 12 shows an exemplary image generated using the method of FIG. 10;

FIG. 13 shows an exemplary image generated using the method of FIG. 11;

FIG. 14 shows a further exemplary image generated using the method of FIG. 11;

FIG. 15 shows a further exemplary image generated using the method of FIG. 11; and

FIG. 16 shows schematic hardware architecture of an exemplary computer for executing any one of the methods described herein.

### DETAILED DESCRIPTION

A method of, and system for, generating an image for use in monitoring user interaction with a computer are described. In the following description, for purposes of explanation, numerous specific details are set forth in order to provide a thorough understanding of the present invention. It will be evident, however, to one skilled in the art that the present invention may be practiced without these specific details.

Exemplary System for Monitoring User Interaction With a Computer

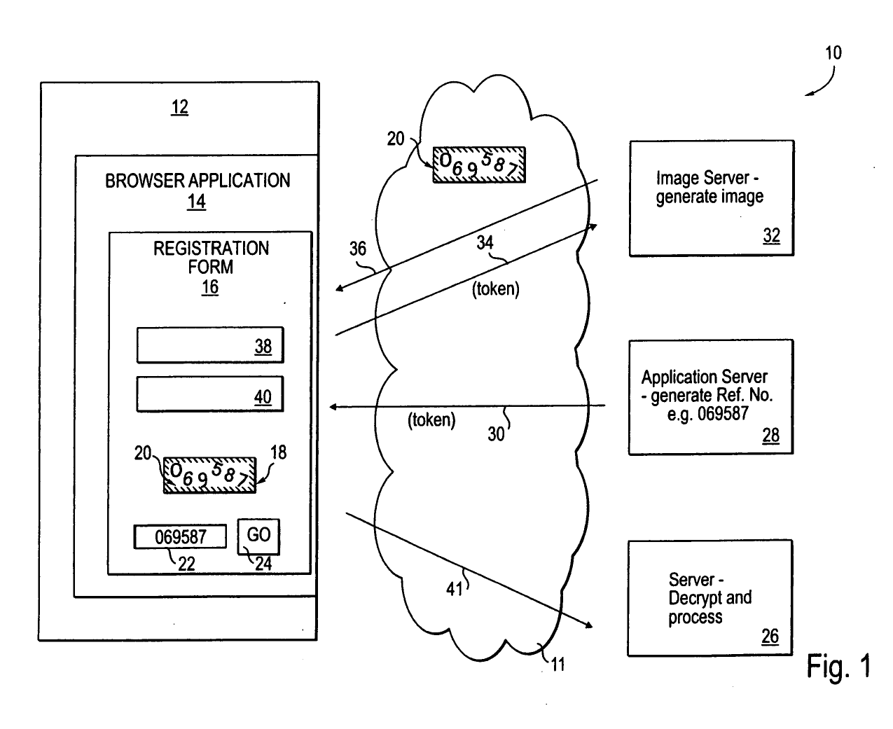

Referring in particular to FIG. 1, reference numeral 10 generally indicates a system, in accordance with an aspect of the invention, for monitoring user interaction with a computer 12. In one embodiment of the invention, the system 10 is used in an Internet environment where a user accesses a web site of an Internet service facility. Accordingly, the invention is described with reference to a user registration process via the Internet 11. However, it should be appreciated that the invention may be applied in any computer environment in which user interaction with the computer is to be monitored.

The computer 12 includes a web browser application 14, which generates a user interface such as an exemplary registration form 16. The registration form 16 includes a display zone 18 for displaying an image 20 including a random reference number and, in order to effect registration, a user is required to read the random reference number from the image 20 and enter it into a user data input field 22. In order to complete registration, the user activates a “GO” button 24 which then communicates the registration information to a registration server 26. As described in more detail below, the image 20 is distorted and modified to inhibit the acquisition of the reference number by an automated process such as a software robot using optical character recognition (OCR). However, the image 20 is sufficiently clear so that the user may read the reference number for entry into the input data field 22. Thus, in order to effect registration, human interaction with the computer 12 is required.

In one embodiment, the reference number is generated by an Internet application server 28, which passes the random number in reference data, e.g., in the form of a token, via the Internet 11 to the browser application 14 as shown by arrow 30. The browser application 14 then passes the token to an image server 32, as shown by arrow 34, during a HyperText Markup Language (HTML) image call. The image server 32 then decrypts the token and includes the reference number in the image 20 in a random fashion whereafter it is communicated, as shown by line 36, to the browser application 14 for inclusion in the display zone 18. After the user has entered the number into the user data input field 22, and completed other details in the registration form, e.g. completed details in the fields 38, 40, the token and the user input data in the field 22 are then communicated to the registration server 26. The registration server 26 then decrypts the token to obtain the reference number, and then compares the number entered by the user with the reference number and, if the numbers match, the registration server 26 may authenticate the user. However, in addition to comparing the two numbers, the registration server 26 also performs a checksum validation and time stamp analysis of the token, as described in more detail below.

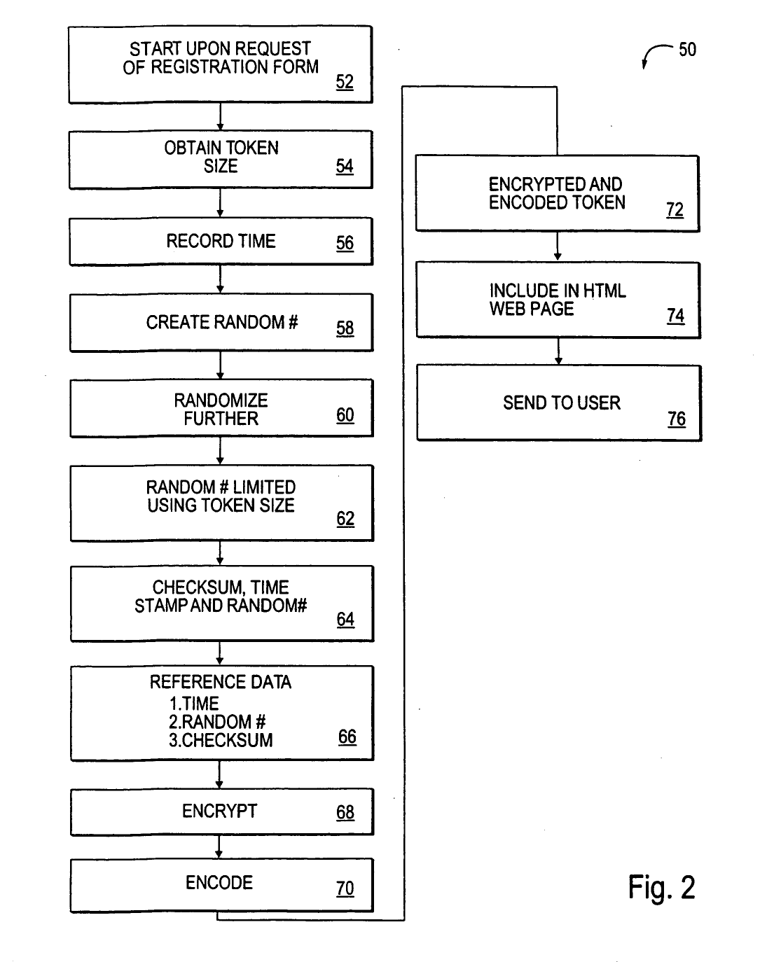

Referring in particular to FIG. 2, reference numeral 50 generally indicates an exemplary method, in accordance with an aspect of the invention, for generating random reference data including a reference string in the exemplary form of a random reference number, for inclusion in the image 20. In one embodiment, the method 50 is carried out in the application server 28. It is to be appreciated that, although the random reference string is in the form of a random reference number, in other embodiments, the random reference string may be numeric, alphanumeric characters and/or any graphical data. However, when the random reference string is in the form of a random number with numerical digits, the system 10 may be language independent.

In an exemplary registration process, the method 50 is initiated when the web browser application 14 requests a registration form from the application server 28 (see block 52). Thereafter, as shown at block 54, the particular token size, to convey the reference data, in the system 10 is determined and is time stamped in milliseconds (see block 56). The random reference number is generated as shown at block 58 and further randomized as shown at block 60. Thereafter, the reference number is limited in size (see block 62) to conform to the token size selected at block 54. A checksum of the time stamp and the reference number is then performed (see block 64) to produce reference data including time data, the reference number, and the checksum (see block 66), which is then encrypted, e.g. using Blowfish, as shown in block 68. The encrypted reference data is then Base64 encoded (see block 70) to produce an encrypted and encoded token (see block 72) which is then included in an HTML web page (see block 74) and sent to the user (see block 76 in FIG. 2 and arrow 30 in FIG. 1).

An example of the token including the reference data generated by the application server 28 is as follows:

| (64 bit) | (32 bit) | (32 bit) |
|---|---|---|
| 1595139460 | 069587 | 59991 |
| Time Stamp | Random # | Checksum |

The time stamp of the token (see block 56 in FIG. 2) indicates when the token was generated and, as described in more detail below, is used by the server 26 to determine whether or not the token has been used before in a valid registration process. The time stamp is typically the time on the application server 28 when the token was created.

Although in the embodiment described above, the token is communicated to the browser application 14 in an HTML web page, it is to be appreciated that it may also, in other embodiments, be passed in a cookie, in other forms, URLs, or the like. Further, the encryption of the token is typically by means of a private key and the random number is generated on-the-fly or dynamically when a request for the registration form 16 is received from the browser application 14. Accordingly, in one embodiment, no library of numbers or images is provided, and different reference data including the random number, is generated each time a request from the computer 12 is processed.

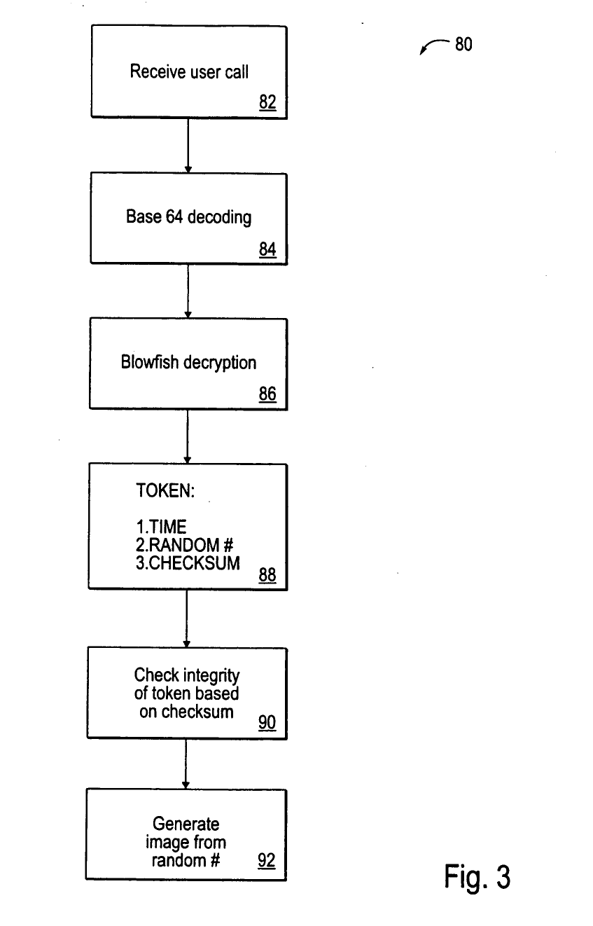

When the browser application 14 performs an image call to the image server 32 to retrieve the image 20 for display in the web page received from the application server 28, it passes the encrypted and encoded token received from the application server 28, to the image server 32 as shown by the arrow 34 in FIG. 1. Referring in particular to FIG. 3 of the drawings, reference numeral 80 generally indicates an exemplary method, in accordance with a further aspect of the invention, for generating the image 20. As shown at block 82, the image server 32 receives the user call from the browser application 14 and identifies the token with the reference data and decodes the reference data using Base64 decoding (see block 84). Thereafter, the reference data is decrypted using Blowfish (see block 86) to obtain decoded and decrypted reference data including the time data, the reference number, and the checksum as shown at block 88. The integrity of the reference data is then checked based on the checksum as shown at block 90 whereafter the image 20 is generated.

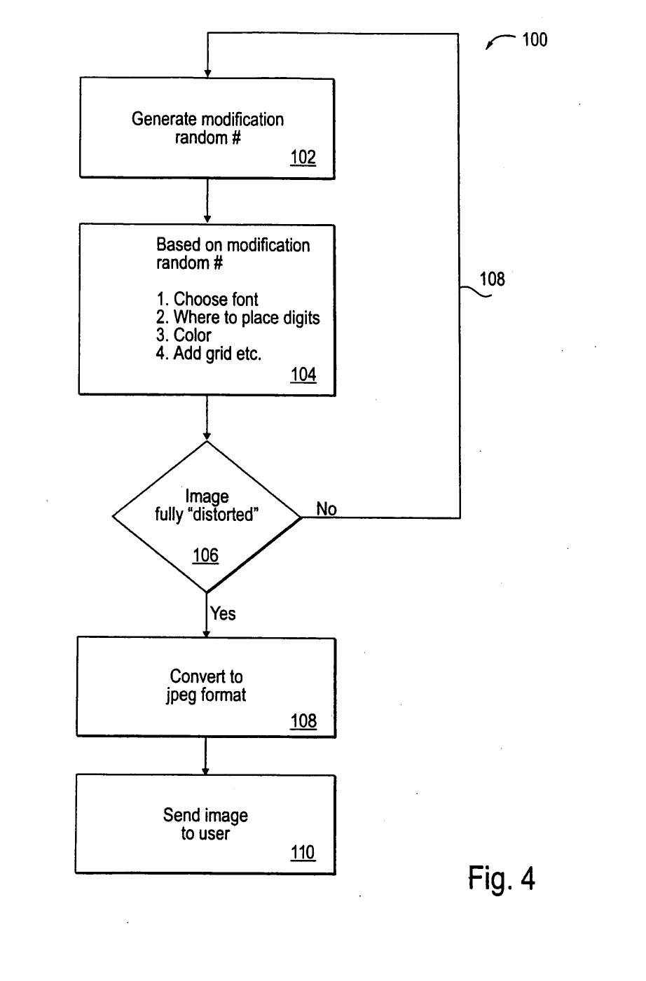

Referring in particular to FIG. 4, reference numeral 100 generally indicates an exemplary method, in accordance with an aspect of the invention, for generating the random image 20 including the random reference number. As shown at block 102, an image modification random number is generated at the image server 32 and, based on the image modification random number, the image is then created and modified. For example, the image modification random number may be used randomly to select one of a plurality of different fonts (see block 104) for each digit in the reference number thereby to inhibit the acquisition of the number by a robot. In one embodiment, a plurality of image modification random numbers may be iteratively generated, as shown by block 106 and line 108, and, in response to each random number, the position in the image 20 in which each digit is displayed may be randomly off-centered, various colors in which the digit is to be displayed may be randomly generated, a grid may be added to the image 20, random distortion or noise may be added to the image 20, and so on (see block 104). Once the image 20 has been sufficiently distorted, it is then converted to a jpeg format (see block 108) whereafter it is sent to the computer 12 as shown at block 110 in FIG. 4 and by the arrow 36 in FIG. 1.

In one embodiment, it is to be appreciated that as the image modification number is a random number, the image not only includes the random reference number, but also includes the number within the image in a random fashion. In one embodiment, the image is distorted or modified so that a modicum of human interpretation is required to assimilate or identify the reference number.

As mentioned above, the browser application 14 displays the image 20 in the display zone 18 so that the user may read the numbers provided therein and manually enter the digits, into the entry form or field 22 via a keyboard of the computer 12. Once the user has completed the entire registration form, the user typically activates the “GO” button 24 in response to which the browser application 14 communicates the user entered data, data entered into the form 16, and the token including the reference data to the server 26 as shown by arrow 41 in FIG. 1.

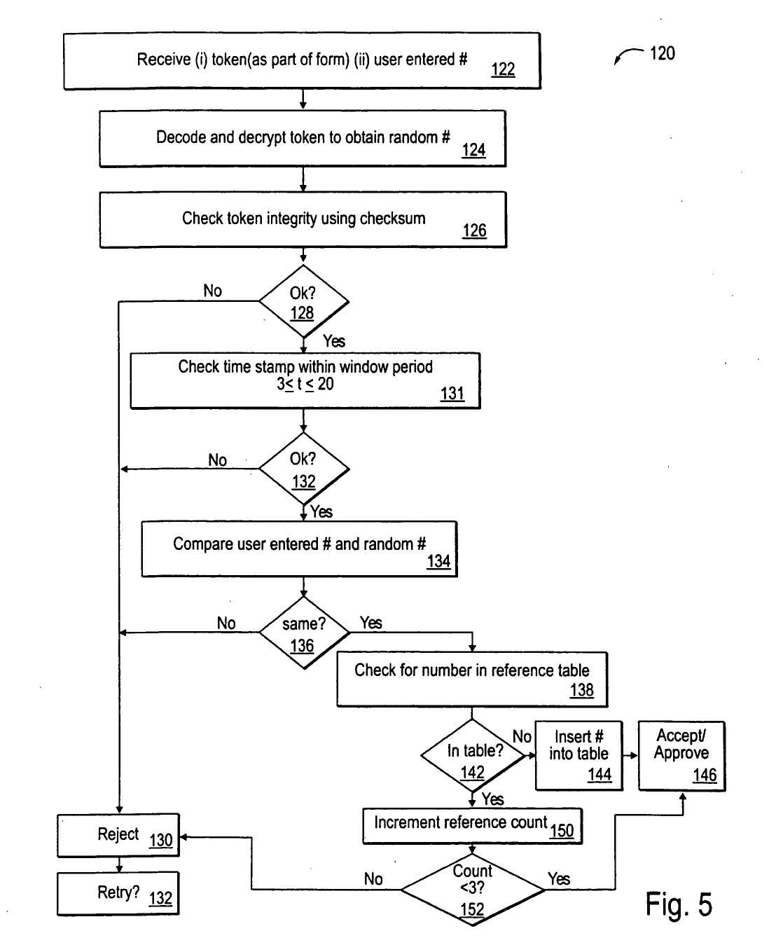

Referring in particular to FIG. 5, reference numeral 120 generally indicates an exemplary method, in accordance with an aspect of the invention, for monitoring user interaction with the computer 12. As shown at block 122, in one embodiment the server 26 receives the token including the reference data, as part of the form 16, as well as the user entered number. The reference data of the token is then Base64 decoded and Blowfish decrypted to obtain the reference data including the random reference number (see block 124). As in the case of the server 32, the integrity of the reference data is then checked using the checksum (see block 126) and, as shown at decision block 128, if the integrity of the reference data of the token is rejected (see block 130), the user is then given a further opportunity of a limited number of opportunities (see block 132) to re-enter the number which is shown in the image 20.

However, returning to decision block 128, if the integrity of the reference data is accepted, then the time stamp of the token is checked to ensure that it is within a particular predetermined time range or window period as shown at block 131. In particular, and depending upon the amount of detail a user is required to enter into the registration form 16, a window period of about 3 to 20 minutes is allowed during which the reference data of the token is valid. If the time stamp indicates a time period of less than about 3 minutes or a time period of more than about 20 minutes, it is assumed that the registration attempt is either by a robot, or a replay attack in which multiple registration attempts using the same token are attempted. Accordingly, as shown at decision block 132, if the time stamp of the token is not within the window period, the registration attempt is rejected (see block 130).

However, if the time stamp is within the acceptable window period, the user-entered number is compared with the reference number to see if they match, as shown at block 134. If the user entered number and the reference number do not match (see block 136) then the registration attempt is rejected (see block 130). In the embodiment depicted in the drawings in which the application server 28 performs the time stamping and the registration server 26 checks the time stamping, time on the servers 26, 28 is synchronized.

In certain circumstances, a user may inadvertently activate the “GO” button 24 more than once, for example, due to a slow refresh rate on a display screen. Thus, in certain embodiments, the reference data may be valid for more than one perceived registration attempt. In these circumstances, if the user entered number and the reference number match, a further check is conducted to determine if the same token has already been used as a basis for a registration validation (see block 138). In particular, the method 120 accesses a table 140 (see FIG. 8) to obtain usage information on the token and its reference data. As shown at decision block 142 in FIG. 5, if the number of the token is not included in the table 140, it is then inserted into the table 140 (see block 144) and its reference count is set at “1” (see column 148 in FIG. 8). Thereafter, the registration process is authenticated or effected, as shown at block 146.

However, returning to decision block 142, if the reference number associated with the token is included in the table 140, its reference count included in column 148 is incremented (see block 150) and the method 120 then checks to see if the count associated with the token exceeds a predetermined maximum number. For example, if the predetermined maximum number is three, then once the count in the table 140 has reached three, any registration attempt after that using the same reference number is rejected (see blocks 152 and 130 in FIG. 5). If, however, the account is less than three, then the registration process may be completed (see block 146).

In certain embodiments, the table 140 includes an age column 154, which is used to check whether or not the time stamp is within the predetermined window period (see block 131). A registration attempt may be selectively rejected dependent upon the count in column 148 and the age of the token as shown in column 154. Comments 156 in FIG. 8 show an exemplary application of the methodology described above in which the time window is 120 minutes and the maximum number of retry attempts using the same reference data is three.

User Interface

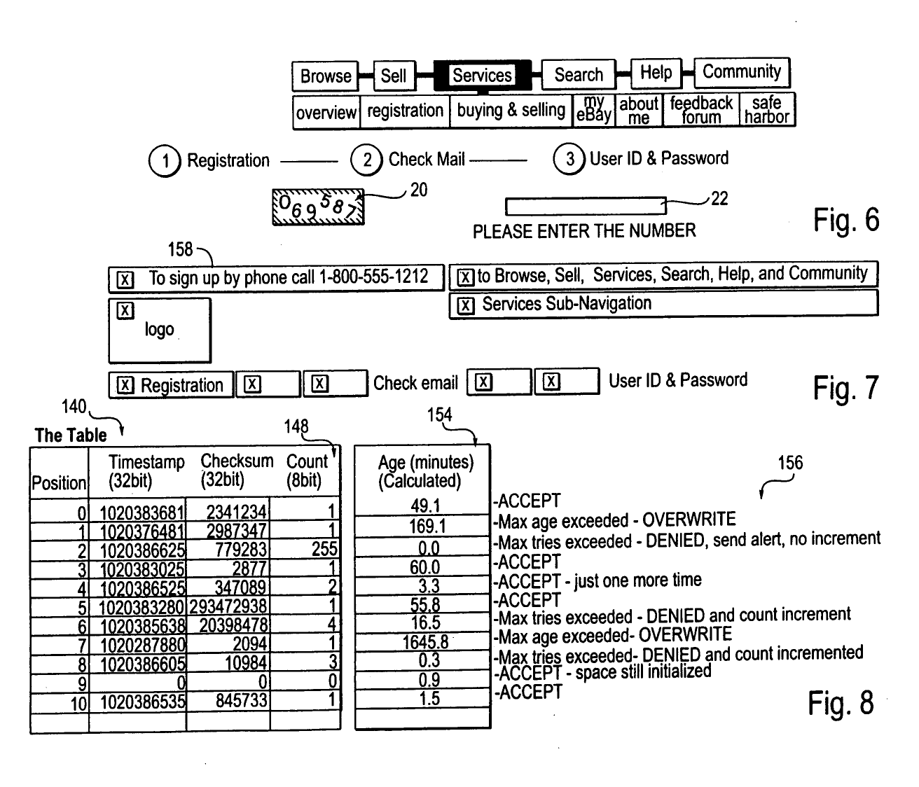

An exemplary screen shot of an embodiment of a user interface served by the application server 28 to the browser application 14 is shown in FIG. 6. The user interface of FIG. 6 is typically generated using HTML and, as mentioned above, although the invention is described with reference to a registration process, it may be used to monitor user interaction with the computer 12 in any other circumstances. As the image 20 is modified in such a fashion that it inhibits identification of the reference number by a robot or any other automated process, the resultant image 20 may be difficult for a visually impaired person to read. Accordingly, as shown in FIG. 7, an alternative sign up or registration procedure may be provided in which a toll free number 158 is provided for a visually impaired person to call and thereby to effect registration.

In the embodiments described above, the servers 26, 28, and 32 are shown as separate servers, which may be located at different facilities. Thus, in one embodiment, the token communicated between the different servers may be the only interaction between the servers 26, 28, 32. In this embodiment, a single centralized table 140 may be provided on the server 26 and it need not be replicated on the servers 28 and 32. However, it will be appreciated that in other embodiments, any two or more of the servers may be combined into a single server.

Image Generation

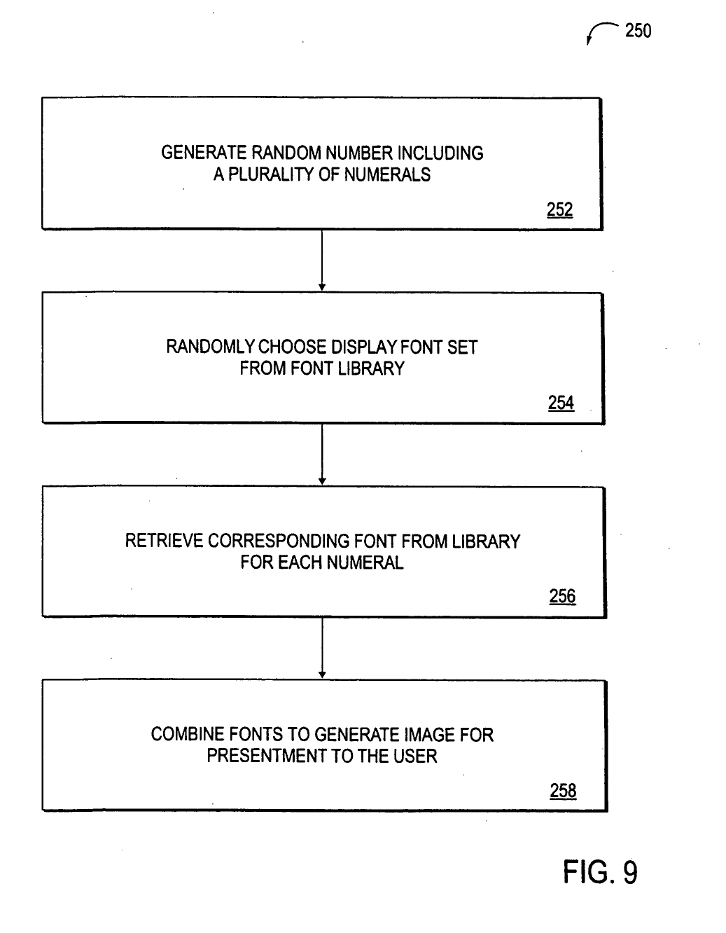

Referring in particular to FIGS. 9 to 15 of the drawings, various methods of generating an image for use in monitoring user interaction with a computer, as herein before described, are provided. When, for example, generating an image 20 for display to the user in the display zone 18, it is desirable to provide an image that is at least not easily recognizable by an OCR device.

Referring in particular to FIG. 9, reference numeral 250 generally indicates a method, in accordance with the invention, for generating an image for use in monitoring user interaction with a computer. The method 250 may, for example, be used to generate or choose a font as shown in block 104 of FIG. 4.

As shown at block 252, the method 250 may initially generate a random number including a plurality of numerals. Although the present embodiment uses random numbers that define reference data comprising a plurality of numerals or digits, it will be appreciated that any reference data comprising a plurality of characters may be used in other embodiments. For example, words (in any one or more different languages), alphanumeric characters, or the like may be generated. Returning to the present example, once the reference data in the form of a random number has been generated at block 252, the method 250 then at block 254 randomly chooses a display font set from a font library. In particular, in one embodiment of the invention, a plurality of different font sets are provided and the method 250, during any one or more human interaction or authentication sessions, chooses a particular font set for use during the current authentication session. In one embodiment, the font sets are handmade by humans and stored in a font library for retrieval each time the method 250 is executed. Each font set may comprise a plurality of font images as described in more detail below.

Once the method 250 has chosen a font set for use in generating the image 20, a corresponding font image that corresponds to each character (a numeral in the present example) of the reference data (a reference number in the present example) is then retrieved from the font library (see block 256). In particular, each font set includes a plurality of font images, which include user identifiable characters (in the present example numerals) that correspond to each digit or numeral of the number generated in block 252. However, the user identifiable characters are distorted so that they are not easily recognized by an OCR device, yet still recognizable by the human eye.

As shown at block 258, the corresponding font images that have been retrieved from the selected font set (e.g., stored in the font library) are then combined to generate or form the image 20 for presentation to the user (see block 258). As mentioned above, in one embodiment, the method 250 may be used to generate the image 20 provided to a user during a registration process. (see FIG. 6) performed via the Internet 11.

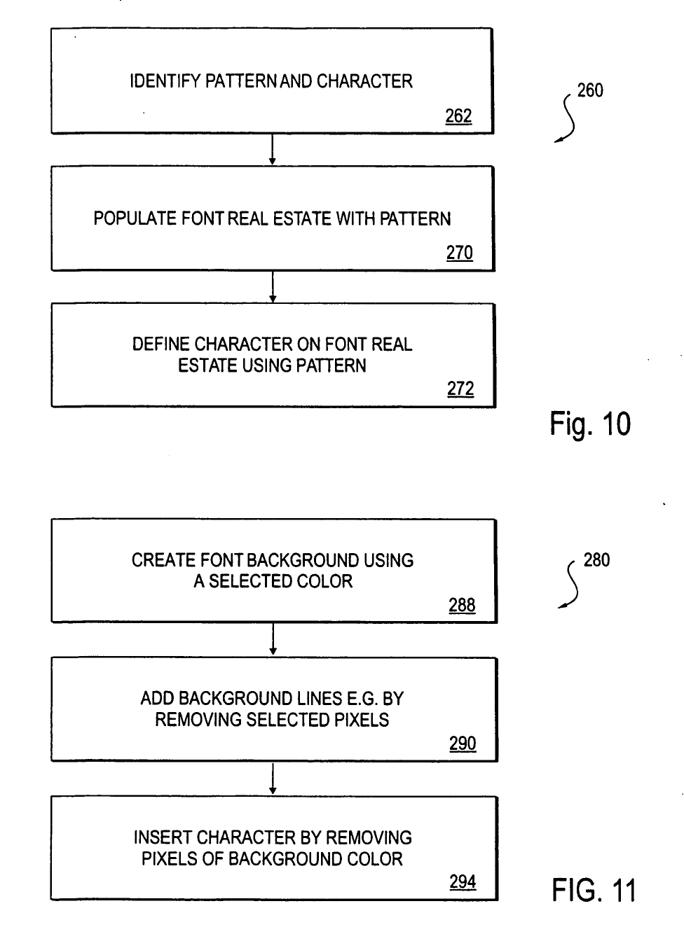

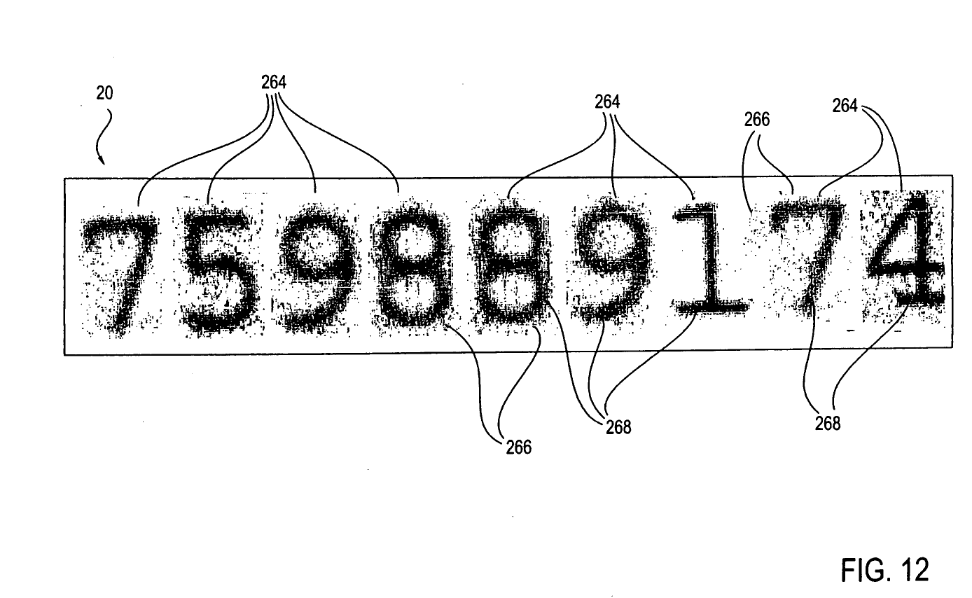

Various techniques may be employed to frustrate recognition of each font image (see FIGS. 12-15) by an OCR or the like device. Referring to FIG. 10, reference numeral 260 generally indicates a method, in accordance with the invention, of generating a font image, in accordance with the invention, which is used in combination with other font images to define the exemplary image 20 presented to the user. As shown at block 262, in one embodiment of the invention a font set may comprise a plurality of font images 264. In particular, in the exemplary image 20 of FIG. 12, nine font images 264 are shown corresponding to each numeral or digit in the number ‘759889174’. It will be noted that in this embodiment, the font images 264 corresponding to the numerals ‘7’, ‘8’ and ‘9’ appear twice. Thus, the same font image 264 may appears any number of times depending upon the random number that is generated in block 252 (see FIG. 10). Each font image 264 includes a font background 266 and a user identifiable character 268. The font background 266 comprises a plurality of patterns that are, for example, randomly provided on the font image 264 and the user identifiable character 268 may be provided by a concentration of the patterns in the outline of a character which, in the present example, is a numeral or digit. For example, the user identifiable character ‘5’ in the font image 264 may be defined by increasing the concentration or density of the pattern in such a fashion so as to define a ‘5’. Thus, as shown at block 270 in FIG. 10, the method 260 may populate the font real estate with any selected pattern (e.g. hearts, stars, pictures, or any other shape or character) and, thereafter, as shown at block 272 the user identifiable characters are defined on the font real estate using the pattern by concentrating the pattern in the shape of the character so that the character is identifiable by a user. In the exemplary embodiment of the image 20 shown in FIG. 12 a transition portion between the user identifiable character 264 and the font background 262 has been blurred or distorted.

When the font set includes a plurality of font images each of which correspond to a numeral, it will be appreciated that for each numeral zero (0) to nine (9) a corresponding font image is provided. Using a combination of the font images (corresponding to the reference numerals zero to nine) any random number generated by method 250 may be presented in an image 20 comprising a plurality of font images 264 that have been combined.

Referring in particular to FIG. 11, reference numeral 280 generally indicates a further method, in accordance with the invention, for generating an image for use in monitoring user interaction with a computer. The method 280 uses a plurality of font images 282 (see FIG. 14) which also, as described above, comprise a font background 284 and a user identifiable character 286. When generating the font image 282, the font background 284 is first created using a selected color (see block 288). Thereafter, as shown at block 290, one or more background lines 292 may be provided by removing pixels from the font background 282. Thereafter, as shown in block 294, a corresponding character that is user identifiable is provided in each font image 282 by removing pixels or effectively “cutting out” image data provided in the background of the font 284.

It will be appreciated that various different colors and backgrounds may be provided in each font image 282. For example, in FIG. 14 a dark background is provided with a single horizontal line 292 and, a transition zone 298 between each user identifiable character 282 and the font background 284 is blurred so that recognition of each font image 284 by an OCR device is frustrated. Further, it would be appreciated that any number of horizontal, vertical, diagonal, oblique or the like lines 292 may be provided in the font image 284.

In certain embodiments, the methods 250 and 260 may be combined to generate the image 20 presented to the user. For example, the image 20 may include a font background 264 defined by one or more patterns (see FIG. 12) and, thereafter, the user identifiable characters 286 (see FIG. 14) may be cut out or removed from the font background 264. In this embodiment, and as described above with reference to FIG. 14, a transition area or portion between the user identifiable character and the font background may be blurred to further frustrate recognition by an OCR device.

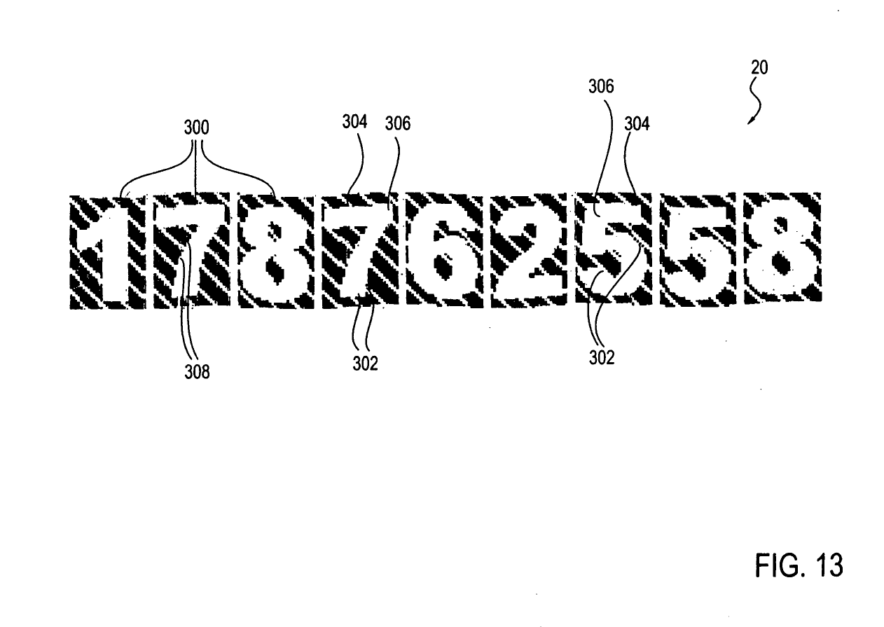

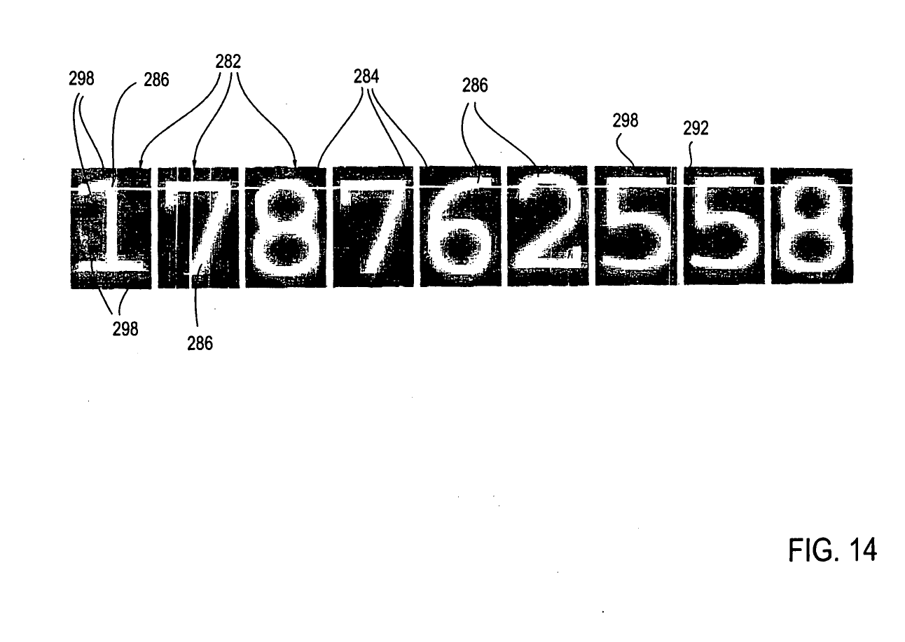

FIG. 13 shows a further embodiment of an image generated using the method 280. The image 20 includes a plurality of font images 300 (nine in the present example) retrieved from a font set comprising ten font images (corresponding to numerals or digits zero (‘0’) to nine (‘9’)). The font images 300 include a plurality of lines 302 extending across a font background 304 to a user identifiable character 306 in the form of an exemplary reference numeral. As in the case of the other embodiments, the lines 302 may extend across the font background 304 in any direction (e.g., diagonally, vertically, and/or horizontally). The lines 304 have irregular borders or edges which, in the illustrated embodiment, are jagged and extend along their length.

Thus, in one embodiment, the border of the lines 302 may include angular protrusions such as sharp notches or saw-tooth-shaped projections. In certain embodiment, a peripheral border 308 of each user identifiable character 306 may be irregular e.g. the border 308 may include angular protrusions as described above. Thus, the border of the lines 302 or the border of the user identifiable characters 308 may include angular shapes set against a differentiated background.

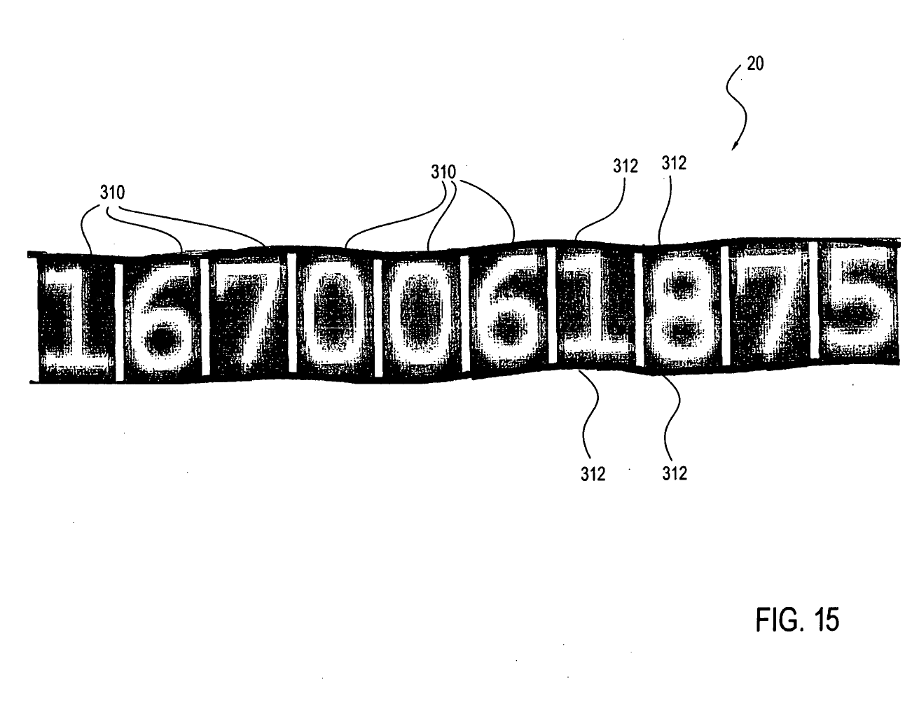

In one embodiment of the invention, font images (e.g., font images 310 in FIG. 15) are combined so that upper and lower borders of the combined font images are shaped in the form of a sine wave.

It is to be appreciated that, although the random reference string is in the form of a random reference number, in other embodiments, the random reference string may be numeric, alphanumeric characters and/or any graphical data. However, when the random reference string is in the form of a random number with numerical digits, the methods 250, 260, 280 may be language independent. In one embodiment, the font images are stored in a font library and retrieved on-the-fly to generate the image 20.

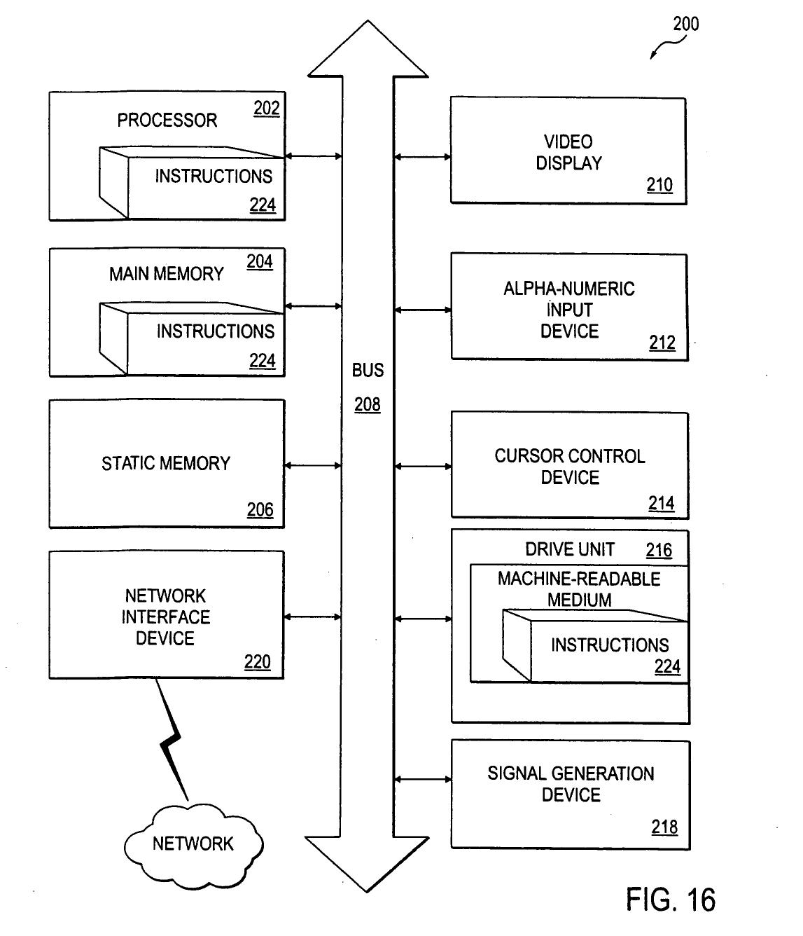

FIG. 16 shows a diagrammatic representation of machine in the exemplary form of a computer system 200 within which a set of instructions, for causing the machine to perform any one of the methodologies discussed above, may be executed. The computer 12 and servers 26, 28, and 32 may resemble the computer system 200.

In alternative embodiments, the machine may comprise a network router, a network switch, a network bridge, Personal Digital Assistant (PDA), a cellular telephone, a web appliance, Set-Top Box (STB) or any machine capable of executing a sequence of instructions that specify actions to be taken by that machine.

The computer system 200 includes a processor 202, a main memory 204 and a static memory 206, which communicate with each other via a bus 208. The computer system 200 may further include a video display unit 210 (e.g., a liquid crystal display (LCD) or a cathode ray tube (CRT)). The computer system 200 also includes an alphanumeric input device 212 (e.g., a keyboard), a cursor control device 214 (e.g., a mouse), a disk drive unit 216, a signal generation device 218 (e.g., a speaker) and a network interface device 220.

The disk drive unit 216 includes a machine-readable medium 222 on which is stored a set of instructions (software) 224 embodying any one, or all, of the methodologies described above. The software 224 is also shown to reside, completely or at least partially, within the main memory 204 and/or within the processor 202. The software 224 may further be transmitted or received via the network interface device 220. For the purposes of this specification, the term “machine-readable medium” shall be taken to include any medium that is capable of storing or encoding a sequence of instructions for execution by the machine and that cause the machine to perform any one of the methodologies of the present invention. The term “machine-readable medium” shall accordingly be taken to included, but not be limited to, solid-state memories, optical and magnetic disks, and carrier wave signals. While the machine-readable medium may reside on a single machine, it is also to be appreciated that it may reside on more than one machine in a distributed fashion.

Thus, a method and system to generate an image for use in monitoring user interaction with a computer have been described. Although the present invention has been described with reference to specific exemplary embodiments, it will be evident that various modifications and changes may be made to these embodiments without departing from the broader spirit and scope of the invention. Accordingly, the specification and drawings are to be regarded in an illustrative rather than a restrictive sense.

1. A method of generating an image for use in monitoring interaction between a user and a computer, the method including:
generating random reference data wherein the reference data comprises a plurality of characters;
randomly selecting a font set from one of a plurality of font sets, each font set comprising a plurality of font images;
retrieving for each character of the reference data a corresponding font image; and
combining the retrieved font images.

2. The method of claim 1, in which the reference data is a random reference number and the characters are in the form of numerical digits.

3. The method of claim 1, wherein each font image includes a font background and a user identifiable character defined by removal of the font background so as to define the user identifiable character.

4. The method of claim 3, wherein the font background includes at least one line defined by removal of the font background so as to define the line and wherein the line has angular protrusions extending along its length.

5. The method of claim 1, wherein each font image includes a font background including a plurality of font patterns, and a user identifiable character defined by a concentration of the font patterns so as to define the user identifiable character.

6. The method of claim 5, in which the font patterns are provided in the font background in a random fashion.

7. The method of claim 5, wherein the font image includes at least one line defined by removal of the font patterns so as to define the line and where and wherein the line has angular protrusions extending along its length.

8. The method of claim 1, which includes generating a sine wave with a random period and combining the retrieved font images so that upper borders of the font images are shaped in the form of the sine wave.

9. The method of claim 1, wherein each font image includes a user identifiable character with a border that has angular protrusions.

10. The method of claim 1, wherein each font image includes a font background and a user identifiable character and wherein a transition between the user identifiable character and the font background is blurred.

11. The method of claim 1, wherein each font image includes a font background including a plurality of font patterns, and a user identifiable character defined by removal of the font background so as to define the user identifiable character.

12. The method of claim 1, which is performed at an image server for serving HTML pages of a web based commerce facility.

13. The method of claim 1, wherein each font set includes a plurality of predefined fonts that are created with human intervention and subsequently stored in a font library.

14. A machine-readable medium embodying a sequence of instructions that, when executed by a machine, cause the machine to:
generate random reference data wherein the reference data comprises a plurality of characters;
randomly select a font set from one of a plurality of font sets, each font set comprising a plurality of font images;
retrieve for each character of the reference data a corresponding font image; and
combine the retrieved font images thereby to generate an image for use in monitoring interaction between a user and a computer.

15. The machine-readable medium of claim 14, in which the reference data is a random reference number and the characters are in the form of numerical digits.

16. The machine-readable medium of claim 14, wherein each font image includes a font background and a user identifiable character defined by removal of the font background so as to define the user identifiable character.

17. The machine-readable medium of claim 14, wherein each font image includes a font background including a plurality of font patterns, and a user identifiable character defined by a concentration of the font patterns so as to define the user identifiable character.

18. The machine-readable medium of claim 16, in which the font patterns are provided in the font background in a random fashion.

19. The machine-readable medium of claim 14, wherein each font image includes a font background including a plurality of font patterns, and a user identifiable character defined by removal of the font background so as to define the user identifiable character.

20. A computer system to generate an image for use in monitoring user interaction with a computer, the system including at least one server to:
generate random reference data wherein the reference data comprises a plurality of characters;
randomly select a font from one of a plurality of fonts, each font comprising a plurality of font images;
retrieve for each character of the reference data a corresponding font image; and
combine the retrieved font images.

21. The system of claim 20, in which the reference data is a random reference number and the characters are in the form of numerical digits.

22. The system of claim 20, wherein the at least one server is an image server for serving HTML pages of a web based commerce facility.

23. A computer system to generate an image for use in monitoring user interaction with a computer, the system including:
means to generate random reference data wherein the reference data comprises a plurality of characters;
means to randomly select a font from one of a plurality of fonts, each font comprising a plurality of font images;
means to retrieve for each character of the reference data a corresponding font image; and
means to combine the retrieved font images.
